(19) United States
(12) Patent Application Publication
(10) Pub. No.: US 2016/0039110 A1
(43) Pub. Date: Feb. 11, 2016

(54) CHAINSAW WITH SELF-LOCKING KNOB ASSEMBLY

(71) Applicant: HUSQVARNA AB, Huskvarna (SE)

(72) Inventors: Christoph Schiedt, Burgrieden (DE); Michael Kistler, Ulm (DE); Daniela Schmitz, Igel (DE); Markus Maag, Neu-Ulm (DE)

(73) Assignee: HUSQVARNA AB, Huskvarna (SE)

(21) Appl. No.: 14/776,425

(22) PCT Filed: Mar. 12, 2014
(86) PCT No.: PCT/SE2014/050297

§ 371 Date: Sep. 14, 2015

(30) Foreign Application Priority Data
Mar. 15, 2013 (SE) PCT/SE2013/050257

(51) Int. Cl. B27B 17/14; F16D 41/12

(52) U.S. Cl. CPC B27B 17/14; F16D 41/12

(57) ABSTRACT

A clamping assembly (130) for clamping a guidebar (120) of a chainsaw (100) to a chainsaw body (110) via a clutch cover (150) including a receiving opening (210) having a series of teeth (212) defined at an internal periphery thereof is provided. The clamping assembly (130) includes an inner knob base (220) rotatably received within the receiving opening (210), a rack element (240) disposed at a portion of the inner knob base (220) to be engageable with the teeth (212), and a knob (140) configured to contact at least a portion of the inner knob base (220). The knob (140) includes a driver reception slot (252) formed therein to engage at least one driver (224) extending from the inner knob base (220). Responsive to rotation of the knob (140), the driver (224) engages the knob (140) to rotate the inner knob base (220) such that the rack element (240) sequentially engages the teeth (212) while tightening the knob (140) to the chainsaw body (110).

### TECHNICAL FIELD

Example embodiments generally relate to chainsaws and, more particularly, relate to a chainsaw provided with means for tensioning the saw chain.

### BACKGROUND

Chainsaws rotate a chain having cutting teeth around a guide bar to cut material such as wood. In order to ensure that the guide bar can be held securely while still allowing the chain to rotate freely around its periphery, many chainsaw models employ a clutch cover to clamp the guide bar to a body portion of the chainsaw. In some embodiments, a knob is provided to enable the clutch cover to be tightened onto the chainsaw body. Rotation of the knob in one direction (e.g., clockwise) may tighten the knob so that the clutch cover is securely held to the chainsaw body. Meanwhile rotation of the knob in the other direction (e.g., counter clockwise) may loosen the knob to allow the clutch cover to be removed.

The nature of the work performed by chainsaws, and the necessary power that is required to enable the chainsaw to cut effectively mean that a chainsaw is generally exposed to a great deal of vibration pressure on the guide bar. The vibration and/or pressure may tend to cause the knob to loosen in some cases. Prevention of loosening of the knob may be accomplished in a number of ways. However, many such ways are either complicated, and therefore costly, or not sufficiently effective. Accordingly, it may be desirable to provide an improved method of locking a knob and clutch cover to the chainsaw body.

### BRIEF SUMMARY OF SOME EXAMPLES

Some example embodiments may therefore provide a self-locking knob that is relatively easy to operate in both the tightening and loosening directions. However, example embodiments may also be self locking so that vibration and/or the like may not loosen the knob. Some embodiments may provide the self locking feature by employing a rack element that engages teeth in a receiving opening of the clutch cover to provide locking of the knob. The knob may also employ an opening element that is configured to move the rack element out of engagement with the teeth when loosening of the knob is desired.

In one example embodiment, a chainsaw is provided. The chainsaw includes a chainsaw body, a chainsaw bar configured to be operably coupled to a cutting chain, and a clutch cover disposed proximate to a portion of the chainsaw bar to facilitate clamping the chainsaw bar to the chainsaw body. The clutch cover includes a receiving opening having a series of teeth defined at an internal periphery thereof. The clutch cover receives a clamping assembly in the receiving opening. The clamping assembly includes an inner knob base rotatably received within the receiving opening, a rack element disposed at a portion of the inner knob base to be engageable with the teeth, and a knob configured to contact at least a portion of the inner knob base. The knob includes a driver reception slot formed therein to engage at least one driver extending from the inner knob base. Responsive to rotation of the knob in a first direction, the driver engages the knob to rotate the inner knob base with the knob such that the rack element sequentially engages the teeth while tightening the knob to the chainsaw body. The rack element is biased to engage at least one of the teeth to lock the knob to the housing when the knob is not rotated. The knob further includes an opening element extending into the reception slot to overcome biasing of the rack element to disengage the rack element from the teeth to enable rotation of the knob in the second direction for loosening the knob.

In another example embodiment, a clamping assembly for clamping a guidebar of a chainsaw to a chainsaw body via a clutch cover including a receiving opening having a series of teeth defined at an internal periphery thereof is provided. The clutch cover may receive the clamping assembly in the receiving opening. The clamping assembly includes an inner knob base rotatably received within the receiving opening, a rack element disposed at a portion of the inner knob base to be engageable with the teeth, and a knob configured to contact at least a portion of the inner knob base. The knob includes a driver reception slot formed therein to engage at least one driver extending from the inner knob base. Responsive to rotation of the knob in a first direction, the driver engages the knob to rotate the inner knob base with the knob such that the rack element sequentially engages the teeth while tightening the knob to the chainsaw body. The rack element is biased to engage at least one of the teeth to lock the knob to the housing when the knob is not rotated. The knob further includes an opening element extending into the reception slot to overcome biasing of the rack element to disengage the rack element from the teeth to enable rotation of the knob in the second direction for loosening the knob.

Some example embodiments may provide an operator with a relatively easy way to clamp the guide bar using a single and relatively simple mechanism and without tools.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective view of a chainsaw according to an example embodiment;

FIG. 2 illustrates a housing of a clutch cover with a receiving opening formed therein according to an example embodiment;

FIG. 3 illustrates a top view of a base portion of the knob such that a driver reception slot formed in the base portion exposes portions of the clamping assembly according to an example embodiment;

FIG. 4A illustrates an elastic rack element in an extended or locked position according to an example embodiment;

FIG. 4B illustrates the elastic rack element in a deflected or unlocked position according to an example embodiment;

FIG. 5 is a block diagram that is descriptive of several states encountered during operation of the clamp assembly according to an example embodiment;

FIG. 6, which includes FIGS. 6A, 6B, 6C, 6D, 6E and 6F, illustrates components of the clamp assembly in conditions that correspond to certain respective ones of the states described in FIG. 5 according to an example embodiment;

FIG. 7 illustrates a perspective view of an alternative structure employing multiple rack elements according to an example embodiment; and

FIG. 8 illustrates a perspective view of an alternative structure employing multiple rack elements and opening elements according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments described herein provide a bar clamping mechanism using a single knob that is self-locking. The self-locking knob may include a rack element that sequentially moves over teeth while rotated in a first direction to lock the knob in place. The knob then remains locked in place, resistant to vibration and loosening, when the knob is not being turned. However, when the knob is turned in a second direction (opposite the first direction), the rack element is removed from contact with the teeth to permit the loosening of the knob.

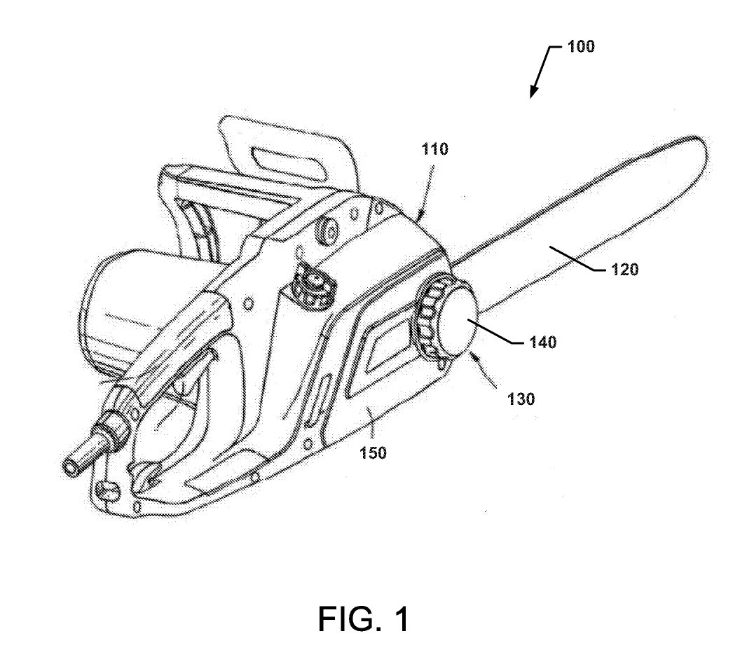

Referring to the drawings, FIG. 1 shows a chainsaw 100 having a body portion 110 housing a motor (not shown). The motor may be an electric motor or an internal combustion engine. A guide bar 120 is attached to the body portion 110 by a clamping assembly 130 that may include a knob 140 that draws a clutch cover 150 of the clamping assembly 130 toward the body portion 110 provided at one end of the guide bar 120. A saw chain may be supported in a peripheral groove (not shown) which extends around the guide bar 120, and is in drivable engagement with a sprocket drive wheel fixed to a sprocket drive shaft drivably connected to the motor.

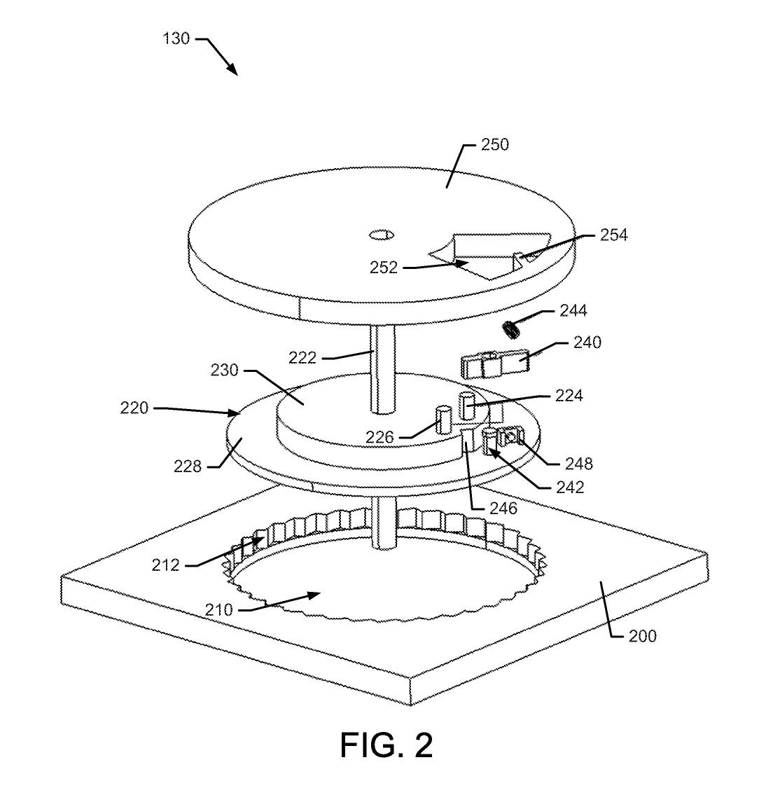

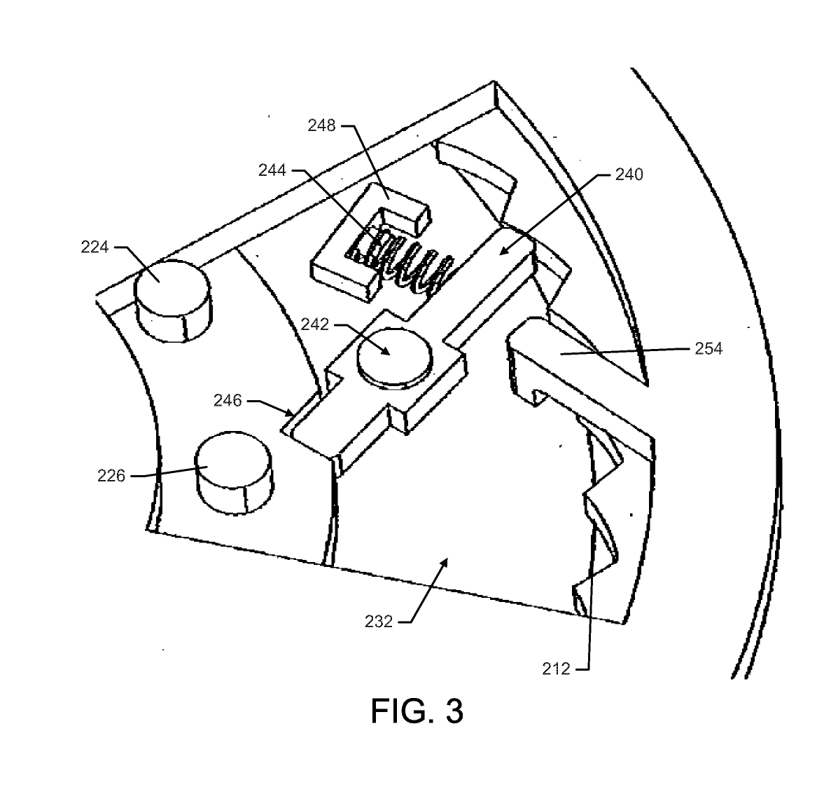

In use, the guide bar 120 may be clamped against an internal clamping surface of the body portion 110 by the clamping assembly 130. FIG. 2 illustrates an exploded view of the clamping assembly 130 in accordance with an example embodiment. In this regard, FIG. 2 illustrates a housing 200 of the clutch cover 150 with a receiving opening 210 formed therein. FIG. 3 illustrates a top view of a base portion of the knob such that a driver reception slot formed in the base portion exposes portions of the clamping assembly. Referring now to FIGS. 2 and 3, the receiving opening 210 includes teeth 212 or reception slots formed around an internal periphery thereof. The teeth 212 are oriented inwardly around the internal periphery of the receiving opening 210 to form a series of slots, grooves or other retaining features two which locking may be accomplished with respect to at least one of such slots, grooves or retaining features at discretely defined intervals. In an example embodiment, the teeth 212 may have a substantially V-shape. However, other shapes are also possible in alternative embodiments.

An inner knob base 220 may be rotatably disposed within the receiving opening 210. The inner knob base 220 may be a substantially plate-like structure having a post 222 extending through an axial center thereof. For purposes of illustration and to facilitate description of an example embodiment via the exploded view of FIG. 2, the post 222 of FIG. 2 is elongated relative to its actual size. Thus, it should be appreciated that the post 222 of a working embodiment would likely be shorter than that which is shown in FIG. 2. At least a distal end of the post 222 may be threaded to facilitate threaded engagement with the knob 140 to clamp the clutch cover 150 to the body portion 110. In an example embodiment, the inner knob base 220 may include one or more drivers (e.g., first driver 224 and second driver 226) disposed to extend from a surface of the inner knob base 220 toward the knob 140. The drivers may extend parallel to the axial center of the inner knob base 220 and therefore also parallel to the post 222. In an example embodiment, the drivers may be equidistant from the post 222. In some embodiments, the inner knob base 220 may include a lower elevation portion 228 and a higher elevation portion 230. The lower elevation portion 228 may have the same diameter as the diameter of the inner knob base 220, while the higher elevation portion 230 may have a smaller diameter than the diameter of the inner knob base 220 to define a channel 232 (see FIG. 3) between the higher elevation portion 230 and the teeth 212.

In an example embodiment, a rack element 240 may be disposed in the channel 232 to extend between the higher elevation portion 230 and the teeth 212. The rack element 240 may therefore be disposed at a portion of the inner knob base 220 to be engageable with the teeth 212. In some embodiments, the rack element 240 may be a relatively rigid member that may be configured to pivot about a fixed axis 242. In an example embodiment, the rack element 240 may be biased toward contact with the teeth 212 via a biasing element such as spring 244. The spring 244 may apply a force to one side of the rack element 240 to push the rack element 240 such that it rotates about the fixed axis 242 and toward the teeth 212. In the embodiment of FIG. 2, one end of the rack element 240 may contact the higher elevation portion 230 and may be fitted to a slot 246 formed in the higher elevation portion 230 to provide a limit to the ability of the rack element 240 to rotate toward the teeth 212. As such, when seated against the slot 246 while the knob 140 is not being rotated, the rack element 240 may engage one of the teeth 212 and lock in place as shown in FIG. 3.

The spring 244 may press against a back stop 248 that may be fixed to the lower elevation portion 228 within the channel 232. In an example embodiment, the spring 244 may push in a direction substantially perpendicular to a direction of extension of the rack element 240. Moreover, in some cases, the rack element 240 may extend toward the teeth 212 such that the longitudinal length of the rack element 240 forms an acute angle relative to a radius of the inner knob base 220.

In an example embodiment, the knob 140 may have a base portion 250 that may be configured to contact at least a portion of the inner knob base 220 (e.g., the higher elevation portion 230) to at least partially enclose the channel 232 between the base portion 250 and the lower elevation portion 228 in the axial direction and between the teeth 212 and the higher elevation portion 230 in the radial direction. The knob 140 may include a driver reception slot 252 formed therein (e.g., in the base portion 250) to engage a respective one of the drivers (e.g., first driver 224 and second driver 226) dependent upon which way the knob 140 is rotated.

Accordingly, for example, responsive to rotation of the knob 140 in a first direction (e.g., clockwise), the first driver 224 engages the knob 140 (e.g., at the driver reception slot 252) to cause the inner knob base 220 to rotate with the knob 140 such that the rack element 240 sequentially engages the teeth 212 while tightening the knob 140 to the chainsaw body portion 110. In an example case, the rack element 240 may be biased to engage at least one of the teeth 212 to lock the knob 140 to the housing 200 when the knob 140 is not rotated. Accordingly, when the knob 140 is not being rotated, the inner knob base 220 may be locked in position relative to the housing 200 via locked engagement of the teeth 212 with the rack element 240. Vibration or other normally experienced forces that may be encountered during operation of the chainsaw 100 may therefore not cause rotation of the inner knob base 220 or the knob 140 so that the knob 140 remains securely fixed in place and the guide bar 120 remains securely clamped to the body portion 110.

Meanwhile, the knob 140 may further include an opening element 254 formed in the base portion 250 to extend into the driver reception slot 252 to overcome biasing of the rack element 240 to disengage the rack element 240 from the teeth 212 responsive to the rotation of the knob 140 in the second direction (e.g., counter clockwise). When the knob 140 is rotated in the second direction, the second driver 226 engages the knob 140 (e.g., at the driver reception slot 252) to turn the inner knob base 220 with rotation of the knob 140. The opening element 254 may therefore disengage the rack element 240 from the teeth 212 to enable rotation of the knob 140 in the second direction (e.g., counter clockwise) for loosening the knob 140.

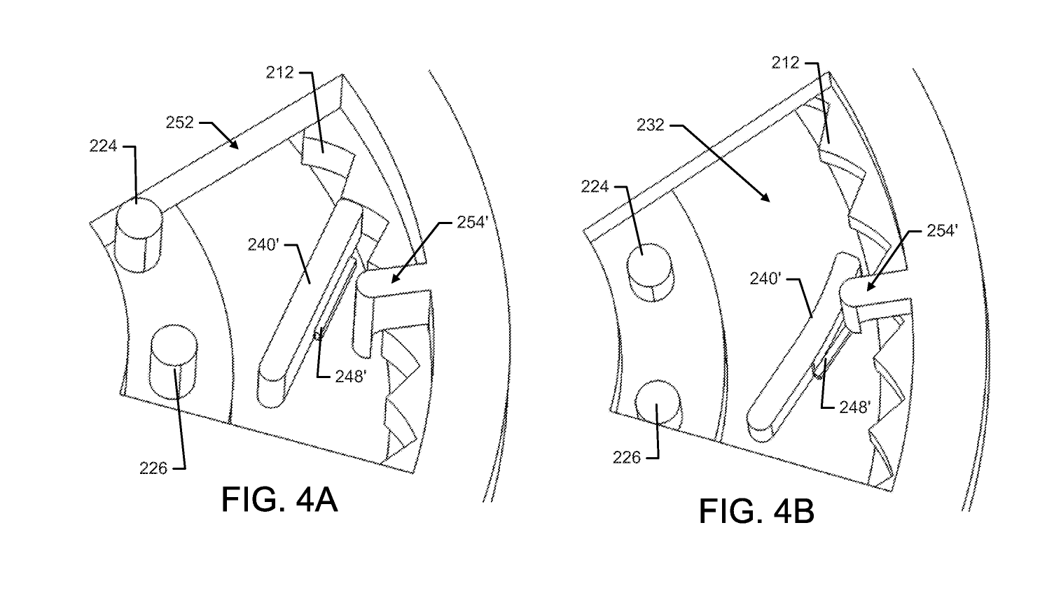

Although the rack element 240 of some embodiments may extend from the higher elevation portion 230 to the teeth 212, other alternative structures may also be employed in some cases. For example, as shown in FIG. 4, which includes FIGS. 4A and 4B, an elastic rack element 240′ may be provided in some embodiments. FIG. 4A illustrates the elastic rack element 240′ in an extended or locked position. FIG. 4B illustrates the elastic rack element 140′ in a deflected or unlocked position. As can be appreciated from FIGS. 4A and 4B, one end of the elastic rack element 240′ may be anchored to the inner knob base 220 (e.g., at the lower elevation portion 228) and the other end of the elastic rack element 240′ may be movable. A backstop 248′ may be provided to limit the ability of the elastic rack element 240′ to move or deflect when the knob 140 is rotated in the first direction. The elastic rack element 240′ may therefore move over the teeth 212 responsive knob base 220 to the housing 200 via the teeth 212 when there is no rotation. However, as shown above, when an opening element 254′ contacts the elastic rack element 240′ responsive to rotation of the knob 140 in the second direction, the elastic rack element 240′ may deflect such that the biasing of the elastic rack element 240′ is overcome and the elastic rack element 240′ is forced by the opening element 254′ out of contact with the teeth 212 such that the inner knob base 220 is free to rotate in the second direction (e.g., the counter clockwise direction) with the rotation of the knob 140 in the second direction.

The opening element 254′ of FIG. 4 may extend inwardly into the driver reception slot 252 substantially perpendicular to the circumference of the base portion 250. In alternative embodiments, as shown in FIG. 3, for example, the opening element 254 may extend into the driver reception slot 252 at an acute angle relative to the circumference of the base portion 250. Moreover, as shown in FIG. 3, the opening element 254 may extend substantially perpendicular to the longitudinal length of the rack element 240 when the rack element 240 is in its extended position. In either case, the opening element 254 or 254′ extends over the teeth 212 and beyond the inward extension of the teeth 212 to enable the rack element 240 or 240′ to be engaged and unseated from the teeth 212 to permit counter clockwise rotation of the knob 140 and inner knob base 220 and loosening of the knob 140.

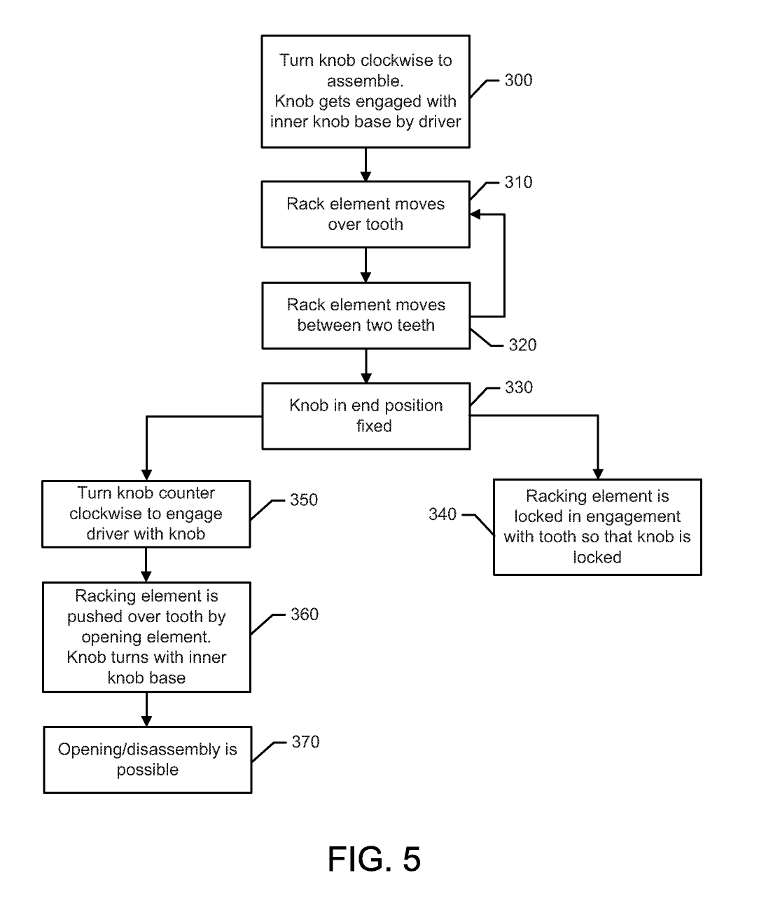

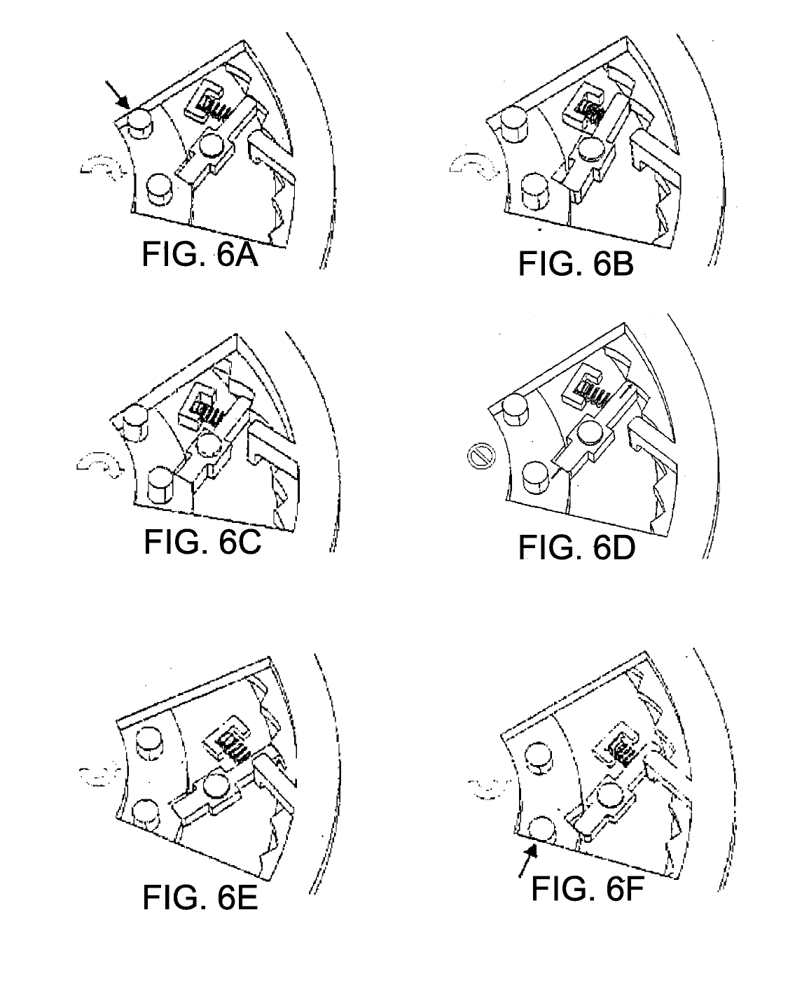

FIG. 5 is a block diagram that is descriptive of several states encountered during operation of the clamp assembly 130 according to an example embodiment. FIG. 6, which includes FIGS. 6A, 6B, 6C, 6D, 6E and 6F, illustrates components of the clamp assembly 130 in conditions that correspond to certain respective ones of the states described in FIG. 5. Referring now to FIGS. 5 and 6, assembling of the clamp assembly may begin with turning of the knob in a first direction (e.g., clockwise) so that the knob engages the inner knob base via the first driver tending to turn the inner knob base with the knob at operation 300. FIG. 6A illustrates rotation of the knob until the driver reception slot sidewalls engage the first driver. While the inner knob base rotates responsive to rotation of the knob, the rack element moves over the tooth as indicated at operation 310 and shown in FIG. 6B. The rack element then passes over the crest or apex of the tooth over which it is moving and moves to a position between two teeth at operation 320 as illustrated in FIG. 6C. Thereafter, the knob may be fixed in an end position, thereby locking the knob and the inner knob base at operation 330 as indicated in FIG. 6D. While the knob is locked, vibrations may be applied during operation of the chainsaw and the vibrations will not cause rotation of the inner knob base or the knob. Instead, the rack element will be biased toward engagement with the tooth so that the position of the inner knob base remains locked and the knob cannot open itself at operation 340.

For disassembly, the knob may be turned in a second direction (e.g., counter clockwise) at operation 350 as shown in FIG. 6E until the knob engages the inner knob base via the second driver tending to turn the inner knob base with the knob. In this regard, FIG. 6E illustrates rotation of the knob until the driver reception slot sidewalls engage the second driver. While the inner knob base rotates in the second direction responsive to rotation of the knob, the rack element is pushed away from contact with the tooth by the opening element as indicated at operation 360 and shown in FIG. 6F. The knob gets rotated in the second direction to loosen itself until it can be removed at operation 370.

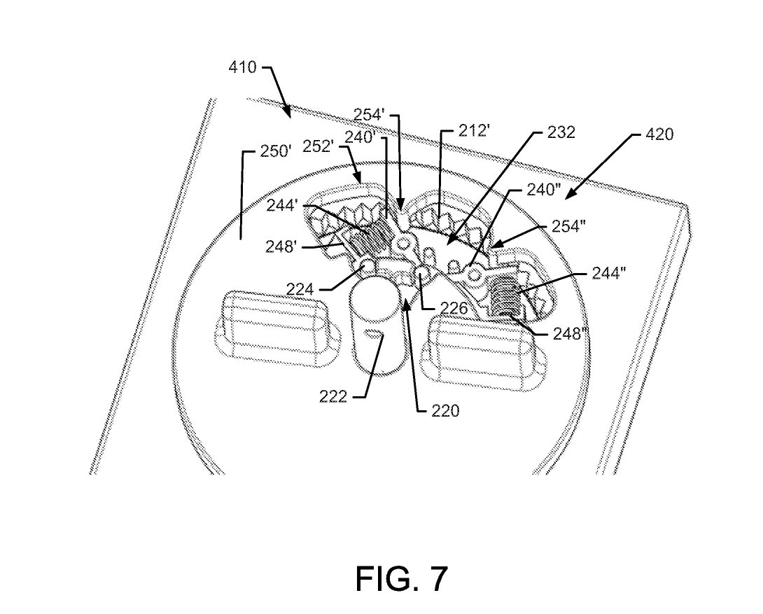

The examples described above provide a ratcheting capability responsive to rotation of the knob in one direction. However, it should be further appreciated that a self-locking knob could be designed to provide the ratcheting capability in two directions. In this regard, for example, one rack element having the structure described above could be oriented in each opposing rotational direction to provide a ratchet capability in both directions. FIG. 7 illustrates a perspective view of an alternative structure employing multiple rack elements and opening elements according to an example embodiment. In this regard, the example of FIG. 7 may include a first ratchet assembly 400, which may be substantially similar to the example described in reference to FIG. 3 above, and a second ratchet assembly 410. The second ratchet assembly 410 may also be similar to the embodiments described in FIG. 3 except that the second ratchet assembly 410 may be oriented in the opposite direction.

As such, for example, teeth 212′ or reception slots may be formed around an internal periphery of a receiving opening. Of note, the teeth 212 of FIGS. 3, 4 and 6 above may have different angles forming each respective side thereof. Moreover, a radius of the teeth 212 may be selected to match a corresponding radius of the rack element 240. However, teeth 212′ of FIG. 7 may be shaped slightly differently. For example, the teeth 212′ of FIG. 7 may have the same angle on each side. Thus, since ratchet assemblies are configured to operate in both directions in the example of FIG. 7, the angles of each side or face of the teeth 212′ should be the same. An inner knob base 220′ may be rotatably disposed within the receiving opening. The inner knob base 220′ may be a substantially plate-like structure having a post 222 extending through an axial center thereof. The inner knob base 220′ may include one or more drivers (e.g., first driver 224 and second driver 226) disposed to extend from a surface of the inner knob base 220′. The drivers may be equidistant from the post 222. The inner knob base 220′ may include a lower elevation portion and a higher elevation portion as described above, and the lower elevation portion and the higher elevation portion may combine to define a channel 232 between the higher elevation portion and the teeth 212′.

The first ratchet assembly 400 includes a first rack element 240′ disposed in the channel 232 to be biased toward contact with the teeth 212′ via a biasing element such as first spring 244′. The first spring 244′ may apply a force to one side of the first rack element 240′ to push the first rack element 240′ such that it rotates about a fixed axis of the first rack element 240′ and toward the teeth 212′. Meanwhile, the other end of the first rack element 240′ may be fitted to a slot formed in the higher elevation portion to provide a limit to the ability of the first rack element 240′ to rotate toward the teeth 212′ as described above. As such, when seated against the slot while the knob is not being rotated, the first rack element 240′ may engage one of the teeth 212′ and lock in place. The first spring 244′ presses against a first back stop 248′, which is fixed within the channel 232.

The second ratchet assembly 410 includes a second rack element 240″ disposed in the channel 232 to be biased toward contact with the teeth 212′ via a biasing element such as second spring 244″. The second spring 244″ may apply a force to one side of the second rack element 240″ to push the second rack element 240″ such that it rotates about a fixed axis of the second rack element 240″ and toward the teeth 212′. Meanwhile, the other end of the second rack element 240″ may be fitted to a slot formed in the higher elevation portion to provide a limit to the ability of the second rack element 240″ to rotate toward the teeth 212′ as described above. As such, when seated against the slot while the knob is not being rotated, the second rack element 240″ may engage one of the teeth 212′ and lock in place. The second spring 244″ presses against a second back stop 248″, which is fixed within the channel 232.

Of note, the first and second rack elements 240′ and 240″ are oriented to interact with opposite surfaces of the teeth 212′ relative to sliding and providing locking engagement. Thus, the first rack element 240′ may prevent unwanted rotation in the counterclockwise direction and the second rack element 240″ may prevent unwanted rotation in the clockwise direction.

Meanwhile, the base portion 250′ includes a driver reception slot 252′ having a first opening element 254′ and a second opening element 254″ provided therein. As shown in FIG. 7, when the inner knob base 220′ is rotated clockwise, the first rack element 240 will ride each tooth and slide into the next tooth. Meanwhile, the second opening element 254″ will lift the second rack element 240″ out of engagement with the teeth 212′ so that the rotation in the clockwise direction is not inhibited. When manual rotation stops, the first rack element 240′ will seat against a corresponding tooth and prevent rotation in the counterclockwise direction as described above, and the second rack element 240″ will seat against a corresponding tooth as well to prevent unwanted rotation in the clockwise direction. The same action may occur in reverse for manual rotation in the counterclockwise direction.

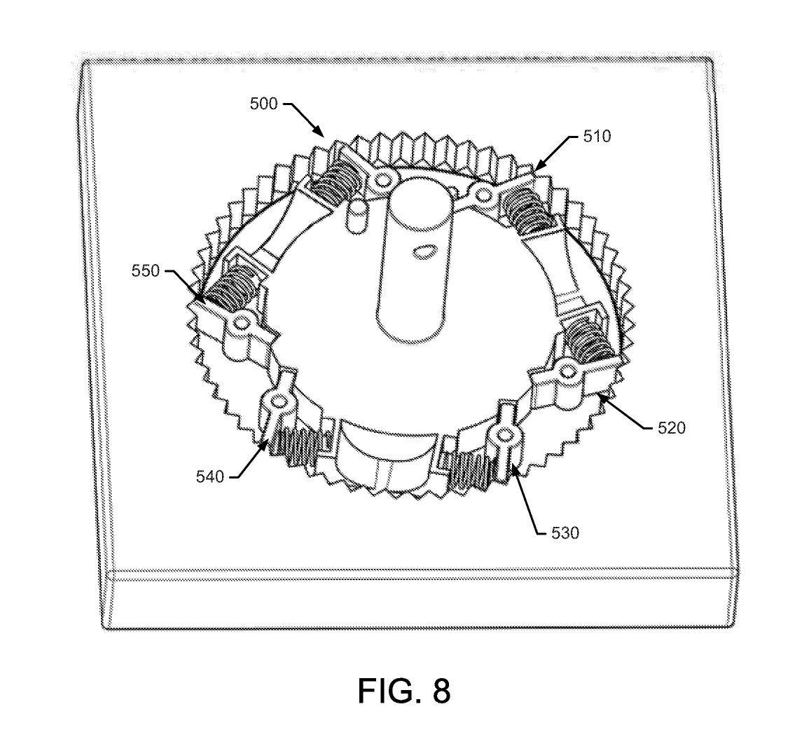

It should be appreciated that the rack elements themselves could be made of elastic material so that the springs (244′ and 244″) can be eliminated. It should also be appreciated that using additional rack elements may enable smaller step sizes to be utilized. In this regard, FIG. 8 illustrates a perspective view of an alternative structure employing multiple rack elements to reduce step sizes according to an example embodiment. As shown in FIG. 8, the dual direction ratchet assembly above may be duplicated any number of times. The example of FIG. 8 creates three separate cooperating rack element pairs (for a total of six rack elements). The rack elements may operate in corresponding ratchet assemblies that operate as described above such that, in this example, a first ratchet assembly 500, a second ratchet assembly 510, a third ratchet assembly 520, a fourth ratchet assembly 530, a fifth ratchet assembly 540 and a sixth ratchet assembly 550 may be provided. It should be appreciated that the base portion (not shown) would include corresponding opening elements for each respective ratchet assembly.

Accordingly, some example embodiment may provide a bar clamping mechanism which employs a knob that is self-locking. For example, the knob may be rotated clockwise to engage a rack element to lock into engagement with one of a series of teeth while the knob is tightened to clamp the guide bar to the chainsaw body. The rack element is biased toward engagement with the teeth. The rack element then locks into place with one of the teeth to prevent loosening of the knob when the chainsaw is operated and vibration is experienced. Thereafter, if removal of the knob is desired, the knob can be rotated in a counter clockwise direction and the rack element may be forced out of engagement with the tooth against the biasing force so that the knob can be loosened and the guide bar can be removed, if desired.

Accordingly, a clamping assembly for clamping a guidebar of a chainsaw to a chainsaw body via a clutch cover including a receiving opening having a series of teeth defined at an internal periphery thereof is provided. The clutch cover may receive the clamping assembly in the receiving opening. The clamping assembly includes an inner knob base rotatably received within the receiving opening, a rack element disposed at a portion of the inner knob base to be engageable with the teeth, and a knob configured to contact at least a portion of the inner knob base. The knob includes a driver reception slot formed therein to engage at least one driver extending from the inner knob base. Responsive to rotation of the knob in a first direction, the driver engages the knob to rotate the inner knob base with the knob such that the rack element sequentially engages the teeth while tightening the knob to the chainsaw body. The rack element is biased to engage at least one of the teeth to lock the knob to the housing when the knob is not rotated. The knob further includes an opening element extending into the reception slot to overcome biasing of the rack element to disengage the rack element from the teeth to enable rotation of the knob in the second direction for loosening the knob.

In an example embodiment, the clamping assembly may include additional, optional features, and/or the features described above may be modified or augmented. Some examples of modifications, optional features and augmentations are described below and may be incorporated individually or in combination with any or all of the other numbered features. In this regard, for example, in some cases, (1) the rack element may include an elastic member biased to contact the teeth or a rotatable rigid member that is biased by a spring to contact the teeth. In an example embodiment, (2) the spring may be disposed to exert a biasing force on the rack element in a direction that is substantially perpendicular to a longitudinal length of the rack element and substantially parallel to a direction of extension of the opening element. In some cases, (3) the rack element may extend to form an acute angle with respect to a radius of the inner knob base. In an example embodiment, (4) the opening element may extend substantially perpendicular to a longitudinal length of the rack element. In some embodiments, (5) the opening element extends over the teeth.

In some embodiments, any or all of (1) to (5) may be employed and the first direction is clockwise and the second direction is counter clockwise. In an example embodiment, any or all of (1) to (5) may be employed and one end of the rack element is fixed while the other end of the rack element is movable. In some cases, any or all of (1) to (5) may be employed and at least two drivers may extend from the inner knob base. In such example, a width of the receiving slot may be greater than a width between the at least two drivers, such that one of the at least two drivers is engaged by the receiving slot when the knob is rotated in the first direction and the other of the at least two drivers is engaged by the receiving slot when the knob is rotated in the second direction. Alternatively or additionally, the clamping assembly may further include a second rack element that defines a ratcheting interface with the teeth relative to rotation of the knob in the second direction and inhibits rotation in the first direction. Alternatively or additionally, the knob further includes a second opening element to overcome biasing of the second rack element to disengage the second rack element from the teeth to enable rotation of the knob in the first direction. Alternatively or additionally, the clamping assembly may include a plurality of rack elements equidistantly spaced apart from each other and oriented such that each rack element ratchets and inhibits rotation of the knob in an opposite direction to the directions in which each adjacent rack element thereto ratchets and inhibits rotation of the knob.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A chainsaw comprising:
a chainsaw body;
a chainsaw bar configured to be operably coupled to a cutting chain; and
a clutch cover disposed proximate to a portion of the chainsaw bar to facilitate clamping the chainsaw bar to the chainsaw body,
wherein the clutch cover includes a receiving opening having a series of teeth defined at an internal periphery thereof, and wherein the clutch cover receives a clamping assembly in the receiving opening, the clamping assembly comprising:
an inner knob base rotatably received within the receiving opening;
a rack element disposed at a portion of the inner knob base to be engageable with the teeth; and
a knob configured to contact at least a portion of the inner knob base, the knob having a driver reception slot formed therein to engage at least one driver extending from the inner knob base,
wherein, responsive to rotation of the knob in a first direction, the driver engages the knob to rotate the inner knob base with the knob such that the rack element sequentially engages the teeth while tightening the knob to the chainsaw body,
wherein the rack element is biased to engage at least one of the teeth to lock the knob relative to the clutch cover when the knob is not rotated, and
wherein the knob further includes an opening element extending into the driver reception slot to overcome biasing of the rack element to disengage the rack element from the teeth to enable rotation of the knob in the second direction for loosening the knob.

2. The chainsaw of claim 1, wherein the rack element comprises an elastic member biased to contact the teeth.

3. The chainsaw of claim 1, wherein the rack element comprises a rotatable rigid member that is biased by a spring to contact the teeth.

4. The chainsaw of claim 3, wherein the spring is disposed to exert a biasing force on the rack element in a direction that is substantially perpendicular to a longitudinal length of the rack element and substantially parallel to a direction of extension of the opening element.

5. The chainsaw of claim 1, wherein the rack element extends to form an acute angle with respect to a radius of the inner knob base.

6. The chainsaw of claim 5, wherein the opening element extends substantially perpendicular to a longitudinal length of the rack element.

7. The chainsaw of claim 5, wherein the opening element extends over the teeth.

8. The chainsaw of claim 1, wherein the first direction is clockwise and the second direction is counter clockwise.

9. The chainsaw of claim 1, wherein one end of the rack element is fixed and the other end of the rack element is movable.

10. The chainsaw of claim 1, wherein at least two drivers extend from the inner knob base, and wherein a width of the driver reception slot is greater than a width between the at least two drivers, such that one of the at least two drivers is engaged by the driver reception slot when the knob is rotated in the first direction and the other of the at least two drivers is engaged by the driver reception slot when the knob is rotated in the second direction.

11. The chainsaw of claim 1, wherein the clamping assembly further comprises a second rack element, the second rack element defining a ratcheting interface with the teeth relative to rotation of the of the knob in the second direction and inhibiting rotation in the first direction.

12. The chainsaw of claim 11, wherein the knob further includes a second opening element to overcome biasing of the second rack element to disengage the second rack element from the teeth to enable rotation of the knob in the first direction.

13. The chainsaw of claim 1, wherein the clamping assembly comprises a plurality of rack elements equidistantly spaced apart from each other and oriented such that each rack element ratchets and inhibits rotation of the knob in an opposite direction to directions in which each adjacent rack element ratchets and inhibits rotation of the knob.

14. A clamping assembly for clamping a guidebar of a chainsaw to a chainsaw body via a clutch cover including a receiving opening having a series of teeth defined at an internal periphery thereof, the clutch cover receiving the clamping assembly in the receiving opening, the clamping assembly comprising:
an inner knob base rotatably received within the receiving opening;
a rack element disposed at a portion of the inner knob base to be engageable with the teeth; and
a knob configured to contact at least a portion of the inner knob base, the knob having a driver reception slot formed therein to engage at least one driver extending from the inner knob base,
wherein, responsive to rotation of the knob in a first direction, the driver engages the knob to rotate the inner knob base with the knob-such that the rack element sequentially engages the teeth while tightening the knob to the chainsaw body,
wherein the rack element is biased to engage at least one of the teeth to lock the knob relative to the chainsaw body when the knob is not rotated, and
wherein the knob further includes an opening element extending into the driver reception slot to overcome biasing of the rack element to disengage the rack element from the teeth to enable rotation of the knob in the second direction for loosening the knob.

15. The clamping assembly of claim 14, wherein the rack element comprises an elastic member biased to contact the teeth.

16. The clamping assembly of claim 14, wherein the rack element comprises a rotatable rigid member that is biased by a spring to contact the teeth.

17. The clamping assembly of claim 16, wherein the spring is disposed to exert a biasing force on the rack element in a direction that is substantially perpendicular to a longitudinal length of the rack element and substantially parallel to a direction of extension of the opening element.

18. The clamping assembly of claim 14, wherein the rack element extends to form an acute angle with respect to a radius of the inner knob base.

19. The clamping assembly of claim 18, wherein the opening element extends substantially perpendicular to a longitudinal length of the rack element.

20. The clamping assembly of claim 18, wherein the opening element extends over the teeth.

21-26. (canceled)
